(19) United States
(12) Patent Application Publication
(10) Pub. No.: US 2024/0126239 A1
(43) Pub. Date: Apr. 18, 2024

(54) INTEGRATING MODEL FOR A TECHNICAL SYSTEM AND METHOD FOR PROVIDING SAID MODEL

(71) Applicant: Siemens Aktiengesellschaft, 80333 München (DE)

(72) Inventors: JENS WINTER, Hessisch Lichtenau (DE); SEBASTIAN WINKLER VON MOHRENFELS, Nürnberg (DE); JAN DEHNER, Nürnberg (DE); MARIE MEZHER SILVA PEREIRA, München (DE)

(73) Assignee: Siemens Aktiengesellschaft, 80333 München (DE)

(21) Appl. No.: 18/276,205

(22) PCT Filed: Feb. 8, 2022
(86) PCT No.: PCT/EP2022/052941

§ 371 Date: Aug. 7, 2023

(30) Foreign Application Priority Data
Feb. 8, 2021 (EP) 21155771.5

(51) Int. Cl. G05B 19/4155

(52) U.S. Cl. CPC G05B 19/4155

(57) ABSTRACT

An integrating model for a technical system composed of at least one of a machine, a component of a machine, and a technical process includes a machine-machine interface, and a plurality of individual models having each assigned a raw model and a data pre-processing, wherein different individual models model different parts of the technical system and have different raw models and a different data pre-processing, and wherein at least one of the individual models is interchangeable for a part of the technical system.

The invention relates to an integrating model for a technical system and method for providing said model. The technical system is, for example, a machine such as a power converter, an asynchronous machine, a synchronous machine, etc. The asynchronous machine or the synchronous machine is, for example, a motor or a generator. The technical system or the machine is also, for example, a pump for fluids or gases for example, a compressor, a turbo compressor (for example for technical gases), a fan (for example for induced drafts or a cooler), etc. The technical system can, for example, also be a component of a machine. For example, one of its components may be the stator or the rotor of an asynchronous machine. A bearing of a motor or generator or a cooling system of a power converter are also examples of a technical system. A technical system is, for example, a technical process for the production and/or processing of a good. Thus a technical process is used, for example, to produce a process gas, supply drinking water, treat drinking water, refine a good containing hydrocarbons, etc. The present invention relates to a method for providing a model for at least one machine, in particular a machine tool. The present invention further relates to a training system, a computer program and a machine-readable (storage) medium. In addition, the present invention relates to a method for simulating operation of the machine or the technical system. The present invention also relates to a simulation system and an associated computer program. The present invention also relates, for example, to a method for virtual testing of the technical system as a plant controller for a process engineering plant and a simulation device for virtual testing of such a plant controller.

Process engineering plants such as refineries or factories are technical systems in which substances are changed in terms of composition, type or properties, and their structures can be extremely complex. A plant can, for example, be made up of a large number of components, such as valves, sensors, actuators and/or the like, which may be networked with one another and/or dependent on one another. Such components are also technical systems. Such plants are usually managed by special, in particular computer-based or at least computer-aided, process control systems, which can in particular take into account the process engineering relations between the various components. Such process control systems include automation technology, in particular automation programs and operating and monitoring programs. Such process control systems, also referred to as plant controllers, are frequently developed on the basis of individual modules which are each assigned to an individual component of the plant and are set up to control this component. Such a module can be understood to be a standardized template of the control software for a component type, wherein when assembling the process control system or plant controller, the module must be adapted accordingly to the specific characteristics of the component in order to enable correct management of the component and thus also of the system as a whole. Plant controllers developed from individual modules, which also represent technical systems, are usually tested by simulation before they are used in a real plant in order to ensure or, if necessary, improve the functionality of the control. The simulation of the plant can be based on models (for example simulation models).

Models from engineering or R&D can, for example, also be usefully employed in the operation of engines and converters. For example, a drive with a converter and a motor will require a temperature model for the rotor, a model for the bearing, a model for the control of the power semiconductors, and so on. The calculation and parameterization of models in drive engineering systems within HMI applications/controllers mostly constitute individual solutions or are computed on hardware-oriented computers, which are mostly created by user-specific engineering. These solutions require a great deal of effort in terms of programming, maintenance, servicing and expansion. If there are errors in the model, it is very time-consuming to identify or correct these while the user process is still under way. A comparison and exchange of different but similar models for a technical system or asset is effectively only possible when the plant is being commissioned.

Models from engineering or development are used in the operation of motors and converters, for example, in order to use these models to carry out analyses, comparisons and predictions about the state of the (drive) system. Some models are based on the fact that they require continuous measurement signals with a high sampling rate (especially in the kHz range). If necessary, signals with various sampling rates and minimum measurement durations are required in order to achieve a corresponding confidence interval for the models. Cloud-based measuring systems are often restricted to a low sampling rate (<=500 ms) by the system, which precludes a real-time analysis. Thus, to date, models with high demands on the measurement signal sampling rate have only been processed and calculated on system-level computers. This means that these models cannot be integrated into a cloud-based computer system.

US 2002/0072828 A1 describes a method for modeling a non-linear empirical process. Based on an initial model, a non-linear network model with several inputs based on the initial model inputs is to be constructed. A global behavior of the nonlinear network model as a whole should generally conform to an initial output of the initial model. The non-linear network model is optimized based on empirical inputs, wherein the global behavior is constrained.

DE 10 2006 054 425 A1 discloses a method for determining a value of a model parameter of a reference vehicle model. In this case, an estimated value of the model parameter is determined several times as a function of a second driving state variable and/or a variable specified by a driver using an artificial neural network. The artificial neural network is adapted using a learning method.

From an article by Lauff Ulrich et. al. titled “Entwicklung und Test verteilter Funktionen Simulation und Virtualisierung von Fahrzeugsystemen” [“Development and testing of distributed functions of simulation and virtualization of vehicle systems” ] in the journal Automobil Elektronik 09-10/2017 dated Sep. 1, 2017 (2017 Sep. 1), a system for the simulation and virtualization of vehicle systems is known. Intelligent systems that automate the vehicle, network it and make it environmentally friendly are paving the way for a new class of automobile. Embedded systems can be tested and validated in virtual environments.

An object of the present invention is to improve, in particular to simplify, the modeling of a technical system. A further object is to improve the interchangeability of, and further develop, models of a technical system in the operation of the technical system without direct intervention. A further object is to allow operationalization (integration and operation) of complex models in a cloud environment without in-depth programming knowledge.

The object is achieved with an integrating model according to claim 1 or with a method for providing an integrating model according to claim 8. Further embodiments are indicated in claims 2 to 7 or 9 to 12.

In an integrating model for a technical system, wherein the technical system is in particular a machine, a component of a machine and/or a technical process and/or a technical plant, the integrating model has individual models, wherein the integrating model has a machine-machine interface, wherein at least one of the individual models is interchangeable. In particular, each individual model is assigned a raw model and data pre-processing, wherein different individual models model different parts of the technical system, wherein individual models are interchangeable for a part of the technical system, wherein the interchangeable individual models have different raw models and different data pre-processing. Raw models, for example, come from different manufacturers and/or are programmed using different software (for example Matlab, Python, C, C++).

In one embodiment of the integrating model, the raw models are programmed in different programming languages. The raw models can be made mutually compatible through the data pre-processing, so that through the data pre-processing the data can be exchanged between the models and further processing is possible. Depending on the perspective, data pre-processing is also data post-processing with regard to an upstream raw model.

The difference in the raw models requires in particular the use of data preparation so that the data between models is or can be made compatible. The difference concerns, for example, a data protocol, a sampling rate, a number format, etc. The technical system is, for example, a drive, wherein parts of such a technical system can be the following: a power converter, air cooling, water cooling, a bearing of an electric machine (a motor or a generator), a rotor of a motor, etc. There can be different raw models for parts of a technical system, which can have different advantages and/or disadvantages. For example, there can for example be a large number of raw models for air cooling of the motor, or a large number of raw models for a bearing for mounting a rotor of the electric machine. Raw models differ, for example, in their accuracy (for example in the range of 0.1% to more like 10%), first sampling type 1 (data streaming blocks in the kHz range, calculation only 2×/24), second sampling type (calculation every minute with a singular value (no streaming)), third sampling type (calculation 2×/24 h with a singular value (no streaming)) and/or a computing time (in particular from a few seconds to a few minutes). The computing times are based in particular on the time constants of the physical and mathematical raw models. For example, data streaming at 8 kHz over 15 s can be used for an FFT analysis of a bearing condition.

Raw models can in particular be selected from a pool. Data processing is provided so that the raw models can be used in the integrating model. In particular, a special data processing module is assigned to each raw model, in particular a module for data pre-processing. Such modules and thus the data pre-processing can differ in particular by the following: data streaming with block formation, data streaming without block formation, averaging for short periods (minutes, hours), averaging for long periods (a few days, weeks, months, years), averaging for very long periods (several years) and/or correlative, in particular time-independent pre-processing (for example quotient formation).

In the case of an electric machine, for example, the actual values (measured values) of the exciter system can be averaged over monthly periods in order to determine the long-term behavior target/actual difference in the exciter control to be obtained. The interaction between different models in the motor and converter and their systematic deviation excluding standstill and transient processes must be taken into account here.

There may be one raw model or several raw models per topic, i.e. for a part of the technical system. Furthermore, different integrating models have a specific composition of raw models, which are in particular of a generic nature.

For example, models for the following parts of a technical system are of a generic nature:
Coolers (both for converters and motors; water- and air-cooled)
Insulation system (different motor types, transformers/choke coils in converters, etc.)
Semiconductors (air or water-cooled).

Generic in this context means that for example cooler properties can be used in the same way despite differing geometries and media. Furthermore for example lifetime considerations of insulation systems (choke coil, transformer, motor winding) or bearings are applied generically, for example, and can therefore be applied to different asset types (for example bearings of turbo compressors, process coolers of customer plants, etc.).

In one embodiment of the integrating model, a switchable logic element is provided between individual models. In this way, individual models can be easily connected to one another or separated from one another. Individual models with the same task, i.e. the same modeling, can also be changed by separating an individual model out of a signal flow and switching another individual model into the signal flow.

In one embodiment of the integrating model, the technical system is at least part of a drive. For example, a first integrating model, a first model system, relates to the overarching topic of water-cooled converters, wherein there are models, i.e. individual models or raw models, for the following sub-topics:
a) the topic of a first individual model is a cooler;
b) the topic of a second individual model is semiconductors;
c) the topic of another individual model is a deionizer;

. . . .

A second integrating model, i.e. a second model system, relates, for example, to the overarching topic of air-cooled converters, wherein there are models, i.e. individual models or raw models, in particular for the following sub-topics:
a) the topic of the first individual model is a semiconductor;
b) the topic of the second individual model is ambient conditions;
c) the topic of the further individual model is an insulation system.

A third integrating model, i.e. a third model system, relates, for example, to the overarching topic of plain bearings of the motor, wherein there are models, i.e. individual models or raw models, for the following sub-topics:
a) the topic of the first individual model is balancing;
b) the topic of the second individual model is bearings (plain bearings, specifically);
c) the topic of the third individual model is an insulation system.

A fourth integrating model, i.e. a fourth model system, relates, for example, to the overarching topic of plain bearings of the motor, wherein there are models, i.e. individual models or raw models, for the following sub-topics:
a) the topic of the first individual model is bearings (rolling bearings, specifically);
b) the topic of the second individual model is coolers;
c) the topic of the third individual model is an insulation system.

The individual models are in particular numerical models. Examples of a machine are a power converter, an asynchronous machine, a synchronous machine and thus also a motor or a generator. Other examples of a machine are a pump for a liquid, a turbo compressor, for example for technical gases, a fan, for example for an induced draft, etc. Examples of a technical plant are an elevator, a belt conveyor, a rolling mill, a refinery, etc. A component of a machine is also to be understood as a technical system. Examples of components of a machine, in particular an electrodynamic machine, are a stator, a rotor, a bearing, a cooling system. The technical process is used, for example, for flue gas mapping, drinking water supply or monitoring of a process. A component or a technical system can be modeled by an individual model. Technical systems can interact and thus form another technical system (an extended technical system). The machine-machine interface is for example an interface of the following type: REST, SOAP, WSDL or RPC. Here, for example, REST stands for Representational State Transfer and has been used in particular in connection with the World Wide Web. In particular, the interface (machine-machine interface) Is a REST-API (Representational State Transfer—Application Programming Interface) interface. The interchangeability of the individual models in the integrating model, allows changes to be made in this flexibly or also over time. The integrating model, which comprises the individual models integrated in it, makes it easier to coordinate them with one another. This is particularly advantageous when the individual models differ, for example, in at least one of the following characteristics: a different level of accuracy, a different measurement depth, a different number of measured variables or a different number of measuring cycles.

In one embodiment of the integrating model, this has a program module. The program module is interchangeable. The integrating model can also have a plurality of program modules, wherein a plurality of the program modules are interchangeable. The program module or the program modules relate, for example, to a characteristic curve calculation and/or a simulation of physical data and/or the parameterization of at least one individual model. The program module can be integrated into an individual model or can be located separately from the individual models in the integrating model, wherein data exchange is provided between at least one individual model and the program module.

In one embodiment of the integrating model, this has a plurality of individual models, wherein data is processed in a first individual model and results data from the first individual model are used as input data for a second individual model. For example, results data from the second individual model can then be used as input data for a third individual model. The data can be processed between the individual models (pre-processing and/or post-processing) in order to adapt the data to the corresponding individual model.

In one embodiment of the integrating model, the integrating model is cloud-based. The integrating model is then therefore integrated into a cloud computing environment. The integrating model can thus be implemented via an IT infrastructure that is made available, for example, via the Internet. In a further embodiment, the integrating model is edge based. In a further embodiment, the integrating model is created in a hybrid form. Thus for example, at least one data-heavy individual model (processes more data than at least one other individual model) can be calculated at the edge and another less data-heavy individual model can be calculated in the cloud.

In one embodiment of the integrating model, the integrating model has data pre-processing, in particular for communication between individual models. Data pre-processing in particular results in data pre-processing for the adaptation of different data interfaces. These can differ, for example, in the sampling rate, the number range, etc. Thus, data to be processed by the individual model, can be adapted for example to an input interface of the individual model. The data pre-processing also relates, for example, to a pre-processing of the data that goes into the integrating model. In one embodiment of the integrating model, the integrating model has data post-processing. The pre-processing and/or the post-processing relates, for example, to the adaptation of data with regard to sampling rate, unit, jitter, etc.

In one embodiment of the integrating model, the integrating model has an external interface to allow the individual models to communicate with the machine-machine interface. The external interface is, for example, a REST API interface. Pre-processing of data can also be provided for this.

In one embodiment of the integrating model, the machine-machine interface is a REST API interface. Here, the machine-machine interface represented an external interface of the integrating model. External means in particular that the data used is from outside the integrating model and/or the data sent is from within the integrating model and leaves the integrating model.

In a method for providing an integrating model for a technical system, an integrating model is used, wherein different individual models are provided for modeling part of the technical system. The technical system is in particular a drive, a machine, a component of a machine and/or a technical process, wherein the integrating model has a first individual model and a second individual model, data from the first individual model is processed in data pre-processing and this processed data is used in the second individual model. Thus, for example, individual models that have different data interfaces can be combined. The drive has in particular a power converter and/or a motor and/or a generator. The power converter is, for example, a rectifier, an inverter or a converter. The drive can be air-cooled and/or liquid-cooled. The motor or the generator has bearings.

In one embodiment of the method, an individual model of the integrating model is exchanged, wherein the data pre-processing is changed. For example, an individual model in the integrating model can be replaced with an improved individual model or an alternative individual model. This applies in particular when the interfaces are different.

In one embodiment of the method, continuous measurement signals, in particular with a sampling rate in the kHz range, are recorded and these are transmitted in blocks for use in the integrating model. In this way, modeling can be enabled even if real-time transmission of the data is not possible.

In one embodiment of the method, signals, i.e. data, of different sampling rates and/or minimum measurement durations are provided in blocks in a parameterizable manner in order to achieve a corresponding confidence interval for the individual models.

In one embodiment of the method, repetition rates of a block-by-block transmission of the data are varied. For example, an adaptation to different bandwidths can then take place.

In one embodiment of the method, a sampling rate and/or a block size are changed, wherein the change takes place in particular depending on the individual model used. Parameters such as the sampling rate and/or the block size can be changed continuously during operation in order to adapt the sampling rate and the recording time of the block sizes. The parameterization also includes, for example, event-based data management, which enables the models to be calculated more precisely, depending for example on an operating state of a (drive) system. In one embodiment of the method, a hybrid computer system is used for the integrating model.

In one embodiment of the method, data from different types of assets (i.e. from different technical systems, machines and/or technical components or technical subsystems) is recorded and stored. With this data and the link to models, i.e. to individual models in an integrating model, calculations can be carried out in the cloud. It is possible to calculate simple and complex models (individual models or integrating models) of drive components such as motors, converters and other components in parallel with operation. With these calculations, conclusions can be drawn about the condition of the components (for example motor, converter, etc.) and maintenance or repairs can be derived from predictive information from the models. Communication takes place in particular via a standardized API. The models can be deployed without specific IT expertise. In particular, no customer-specific engineering is necessary, even for more complex systems. In this way, the costs for commissioning and/or operation can be kept low in comparison to a pure plant solution. In particular, maintenance and care can be kept simple and are for example easy to implement over the entire plant life cycle.

In one embodiment of the method, parameterizations, changes and/or adjustments to the models take place online in the cloud and are immediately available. This improves the ability to react to changes, for example.

In one embodiment of the method, the models are operationalized. An integrating model can, for example, model an entire drive train, wherein individual models are provided for the electrical components.

In one embodiment of the method, individual models from standardized tools (for example Ansys, Varfem, Matlab, etc.) can be used. Individual models can be uploaded to the integrating model, wherein deployment, including linking with the measurement data of the assets (mapping of the properties), takes place. The modules and/or models are available in particular as graphic elements and can be linked to one another. The measurement results of the models can also be evaluated directly. From these, in particular, notifications and values are generated that can be further processed in other applications, for example for KPIs or recommendations for action.

In one embodiment of the method, continuous measurement signals are recorded with a high sampling rate (in the kHz range) and these are transmitted in blocks.

In one embodiment of the method, signals of different sampling rates and minimum measurement durations are provided in blocks in a parameterizable manner in order to achieve a corresponding confidence interval for the models. Other parameters are for example the repetition rates of the block transmission.

In one embodiment of the method parameters can be changed continuously during operation in order to adapt the sampling rate and the recording time to the block sizes.

In one embodiment of the method, the parameterization includes an event-based data management, which enables the models to be calculated more precisely, depending for example on an operating state of a (drive) system.

A possible advantage of operating models in the cloud is that they can be maintained and updated quickly. With the hardware-related calculation of the models, the advantage of the speed of the calculations is predominant. The provision of the measurement data in blocks and in a parameterizable manner allows the calculation of a model with stringent measurement requirements in a cloud environment with relatively high accuracy. The effectiveness and (operating) costs of models in a cloud environment are much lower.

In one embodiment of the method, the integrating model for example also has the following:
a parameterizable data provision via a standardized interface (API), and/or
a scalability of data-driven numerical models, without additional hardware (apart from standard connect modules), and/or
no need for a specific parameterization of models, and/or
a simple remote maintenance, and/or
a high level of accuracy when determining the state of the drive system using adaptive measurement methods, and/or
a parameterization capability and provision of measured values in blocks with variable scanning and length.

The object is also achieved by a computer program product which has computer-executable program means and is suitable when run on a computer facility with processor means and data storage means, wherein this is used to carry out a method of the type described.

If a computer program product is provided which has computer-executable program means and, when executed on a computer facility with processor means and data storage means, is suitable for carrying out a method according to one of the types described, then this can be carried out, for example, in the cloud, on an edge device and/or in a hybrid manner. In this way, an underlying objective can be achieved by a computer program product that is designed to simulate an operating behavior of the technical system.

The features of the individually claimed or described items can be combined with one another.

In the following, the invention is illustrated and explained in more detail by way of example with reference to figures. The features shown in the figures can be combined to form further embodiments without departing from the invention. The same reference symbols have the same meaning in the different figures, in which, shown schematically:

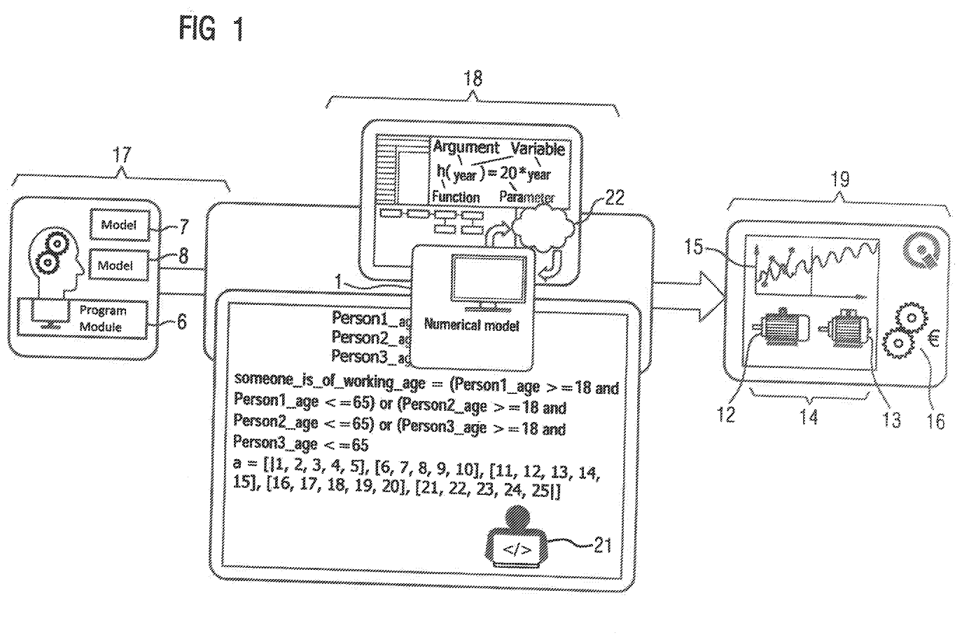

FIG. 1 shows a use of the integrating model;

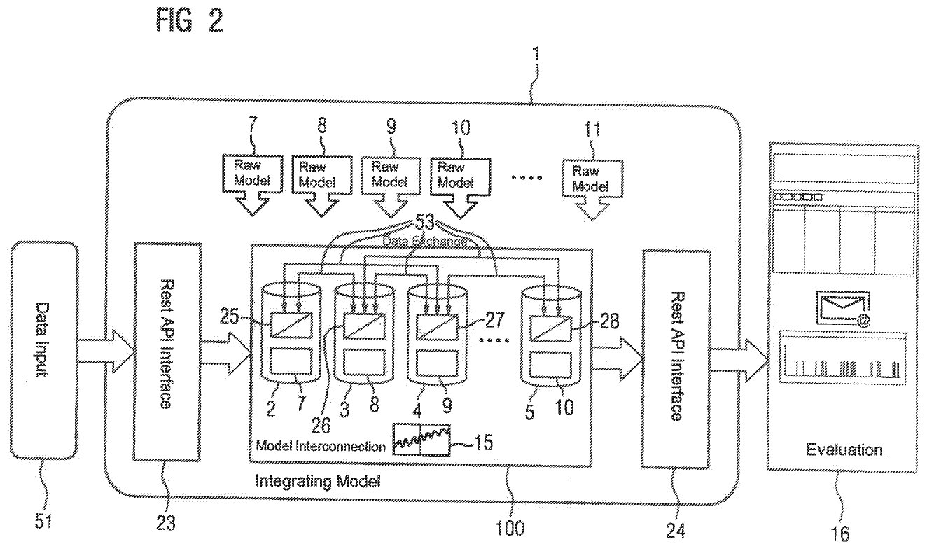

FIG. 2 shows a data stream;

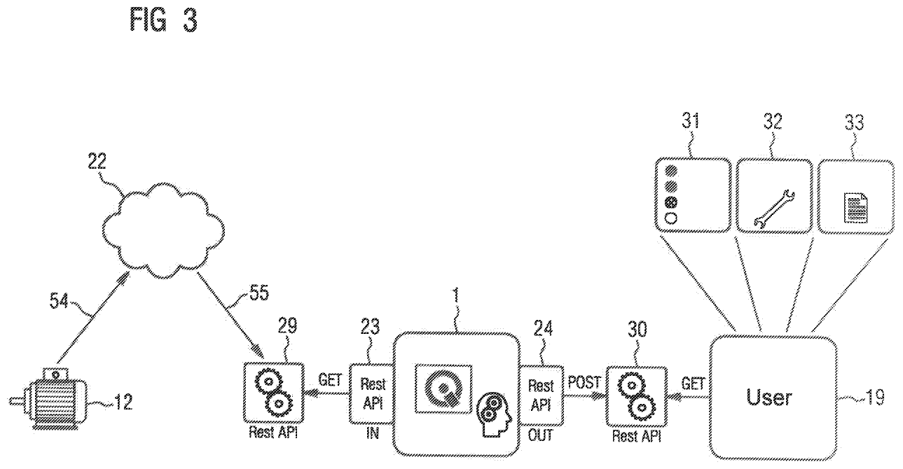

FIG. 3 shows an embedding of the integrating model in the use of a technical system;

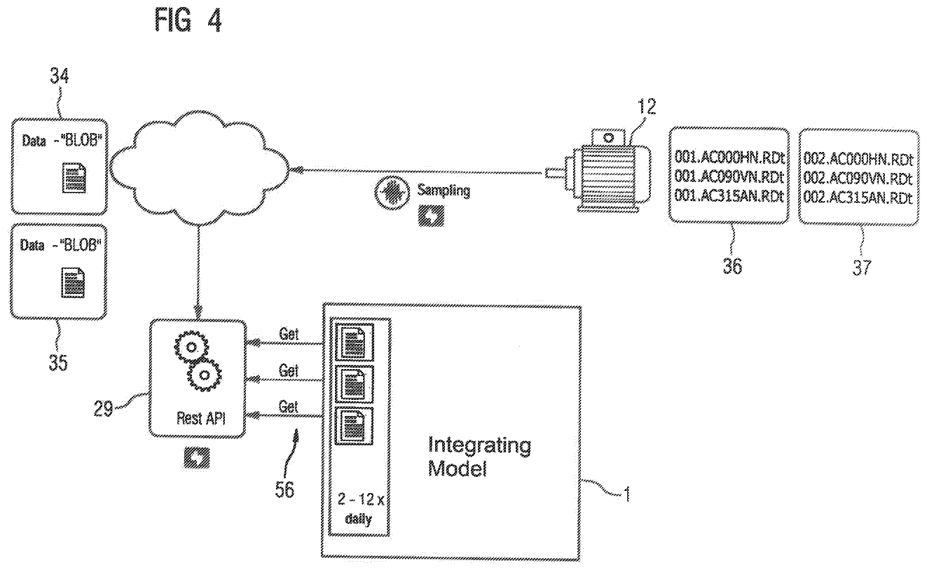

FIG. 4 shows a use of data packets in a real-time environment;

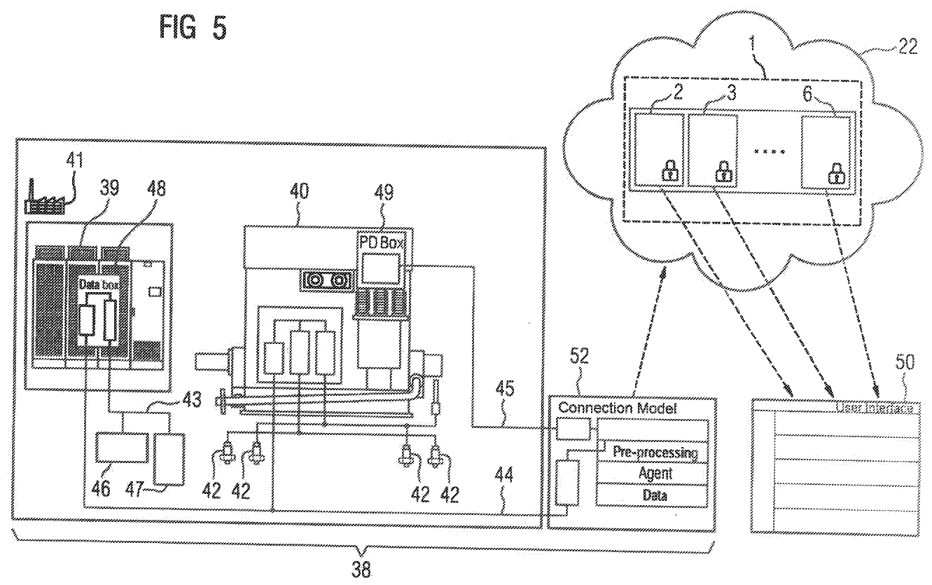

FIG. 5 shows an integration of the integrating model; and

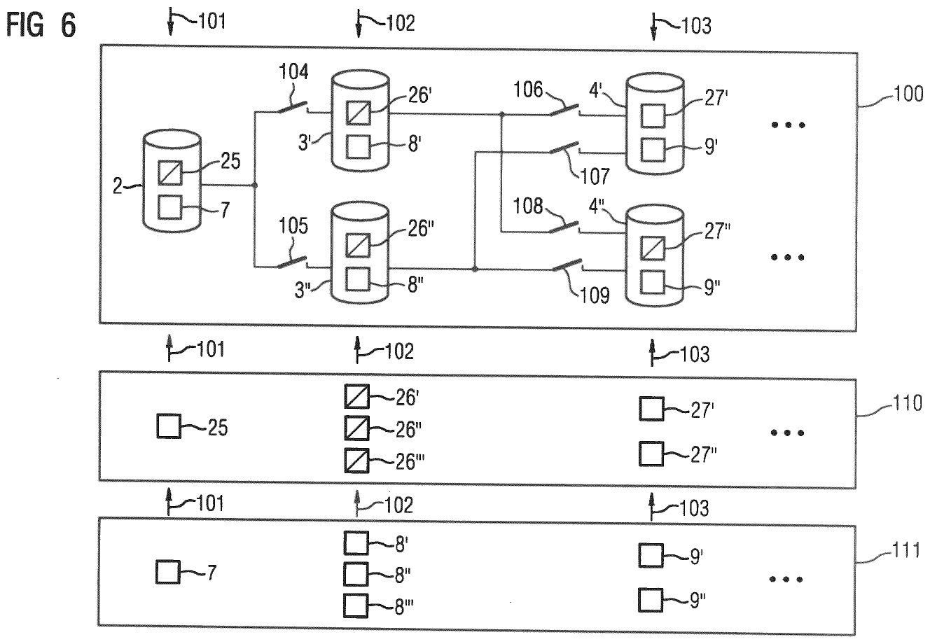

FIG. 6 shows a model system with interconnected individual models.

The representation according to FIG. 1 shows a use of the integrating model 1. This applies in particular to the transfer of a model (for example from development) to another application. FIG. 1 shows three areas, a first area 17, a second area 18, and an area 19. The first area 17 relates to the provision of a raw model 7 and 8 or the provision of a program module 6. The raw models 7 and 8 can be programmed on different systems such as MATLAB or Python. The first area 17 relates in particular to models 7, 8 and program modules 6, which are used in research and development (R&D) or in engineering. The provision of program modules and/or raw models takes place, for example, via the Internet and/or via storage media such as flash memory CD-ROMs or the like.

The second area 18 relates to a parameterization, use or operation. Raw models as well as program modules from the first area 17 are thus transferred to the second area 18. In the second area 18 there is an integrating model 1, which is in a cloud 22 or interacts with it and/or interacts from it. In the integrating model 1 there are numerical models or the integrating model 1 is in particular a numerical model. The integrating model 1 can for example be monitored, parameterized, programmed and/or maintained via human intervention 21. The second area 18 relates in particular to the integration of models in an application, in particular an application in a platform. Parameters of the model are accessible to a user 21. Access by a user, i.e. human intervention, can take place locally and/or remotely, i.e. at a distance.

The third area 19 relates to monitoring and/or prediction functions. Data from the second area 18 are therefore used in the third area 19. In the third area 19 there is, i.e. a prediction of a curve 15, a technical or monetary evaluation 16 and/or the consideration of a technical system 14, which has a first machine 12 and a second machine 13, for example. The third area 19 relates in particular to the operation, evaluation and continuous improvement of models. For example, a digital twin can be implemented. It is possible, for example, to determine whether a model works. Furthermore, it is possible, for example, to propose an adaptation of parameters based on the monitoring. Results of the monitoring and/or the prediction can in particular also be used to design real or modeled technical systems (for example a machine or a technical plant). Monitoring makes it possible, in particular, to calculate a prediction of errors or alarm states. The models, i.e. the individual models or the raw models, relate to or are, for example:
Cooler model for cooling an electric machine;
Arrhenius model (describes the leaching of molecules from solids—used for insulation monitoring and/or aging of materials);
Rotor model of an electric machine;
Bearing model for moving parts of an electric machine.

A parameterization can take place internally via a user or externally via an interface such as an API interface. The parameterization relates, for example, to the physical properties of at least one asset, i.e. a component. The component is, for example, a bearing, a rotor, a power converter, residual current monitoring, a machine, etc. As a result, the API can access a database, for example, and retrieve the parameters for the asset from there. For example, types of bearings used can be stored in the machine data. For example, data can then be queried via bearing types, such as whether the bearing is for example a ball bearing or a needle bearing and the number of balls or needles it contains.

The representation according to FIG. 2 shows a visualization of data streams, as well as a visualization of key figures, recommendations and/or the linking of properties. The integrating model 1 is shown. This has a plurality of raw models 7,8,9,10 and 11. These raw models 7,8,9 and 10 are integrated into individual models 2,3,4 and 5. The individual models 2,3,4 and 5 have modules for data processing 25,26,27 and 28. The individual models 2,3,4 and 5 are designed in such a way that data exchange 53 can take place between them. The individual models 2,3,4 and 5 can be connected in series one behind the other. The interconnection of the individual models 2,3,4 and 5, i.e. their data connection, takes place in the model interconnection 100. A facility for prediction 15 can, for example, record or continue a time series. A facility for parameterization can also be provided. The integrating model 1 has external interfaces 23 and 24. The external interfaces 23 and 24 are of the REST API type, for example. For example, data can be fed from a data input 51 via the input interface 23 to the individual models 2,3,4 and 5. The data can be fed to an evaluation 16 via the output interface 24. A drive system, for example, can be analyzed as part of the evaluation. Furthermore, notifications, recommendations, e-malls and/or generated key performance indicators (KPIs) can be displayed alphanumerically or graphically.

The representation according to FIG. 3 shows an embedding of the integrating model in the use of a technical system. An electric machine 12, such as for example an electric motor, has at least one sensor and a data connection. The electric machine 12 sends data 54 to the cloud 22. The data is first stored there, for example. Thereafter, data 55 is offered via a data interface 29 of the REST API type. The data can be requested via an external interface 23 of the REST API type of the integrating model 1. The integrating model 1 can carry out modeling with the data and, for example, calculate an approximation for the need for a shutdown. The integrating model 1 can forward calculated data via an external interface 24. This also takes place, for example, via a REST API interface. This exported data can also be stored in the cloud and/or locally. The data is fed to a use 19. This is, for example, an analysis facility for a drive system. Functions 31, 32 and 33 such as alarms, warnings, predictions, timelines, reports, recommendations, etc. can thus be created and displayed.

The representation according to FIG. 4 shows the use of data packets in a real-time environment in the model. Sensor data 36,37 is generated by the machine 12. Scanned sensor data is transferred to the cloud and is available there as data blocks 34,35. These data blocks are offered for query via the data interface 29 of the REST API type. The integrating model 1 queries the data blocks 34,35 via a query cycle 56. The model then has enough data to start a simulation. The data blocks are in particular BLOBs (Binary Large Objects). The exchange of data can be parameterized via properties/measured value names. The measured values can for example be high-resolution (data BLOBs), time series or individual status bits, depending on the application. Of course, there is also a combination of the measured values, for example data exchange of individual bits and high-resolution data, for example to start an event-based calculation.

The representation according to FIG. 5 shows an integration of the integrating model 1. In a plant/factory 41 there is a power converter 39 and a motor and a motor 40. The power converter 39 has a data box 48. The motor 40 has a data box 49. The data box 48 is connected to a bus system 43. A controller 46 and a protection system 47 are also connected to this bus 43. The data box 48 is connected to a connection module 52 via a data link 44 (for example via fiber optics). The connection module 52 is used to process, collect and forward data. The motor 40 has sensors 42. Data from the sensors 42 can be sent to the data box 49. The data box 49 sends the data via a data connection 45 (for example via a fiber optic connection) to the connection module 52. The connection module 52 sends the data to the cloud 22. The integrating model 1 is located in the cloud 22 or the integrating model 1 can be reached via the cloud 22. The integrating model 1 has various individual models 2,3, . . . , 6, which can be secured against unauthorized access. A user interface (operating interface) 50 is provided for a user to operate the integrating model 1 or to query data from the integrating model 1.

The representation according to FIG. 6 shows a model interconnection 100. To generate the model interconnection 100, the desired raw models 7, 8′,8″,8′″,9′,9″ are selected from a pool 111 of raw models and integrated into the model interconnection 100 together with associated data pre-processings 25,26′,26″,26′″,27′,27″ from another pool 110. A group of raw models each relate to a topic to be modeled (for example: rotor temperature, bearing current, load torque, etc.). The raw model 7 and the data pre-processing 25 are assigned to a first topic 101. For a second topic 102, for example, there are three raw models 8′,8″,8′″ and 3 data pre-processings 26′,26″,26′″ available, wherein only two of them are selected for the model interconnection and are integrated there. For a third topic 103, for example, two raw models 9′,9″ and 2 data pre-processings 27′,27″ are available, wherein only all those for the model interconnection 100 are selected and integrated there. Within the model interconnection 100, the individual models 2,3′,3″,4′,4″ are interconnected in terms of data technology, wherein switches 104 to 109 (switchable logic elements) are provided for this purpose. Thus, individual models can be connected or disconnected without the model interconnection having to be expanded by further raw models. In this way, for example, a comparison of models with different raw models is easy to generate.

What is claimed is:

1.-12. (canceled)

13. An integrating model for a technical system composed of at least one of a machine, a component of a machine, and a technical process, the integrating model comprising:
a machine-machine interface; and
a plurality of individual models having each assigned a raw model and a data pre-processing, wherein different individual models model different parts of the technical system and have different raw models and a different data pre-processing, and wherein at least one of the individual models is interchangeable for a part of the technical system.

14. The integrating model of claim 13, wherein the different raw models are programmed in different programming languages.

15. The integrating model of claim 13, further comprising a switchable logic element disposed between the individual models.

16. The integrating model of claim 13, wherein the technical system comprises at least part of a drive.

17. The integrating model of claim 13, wherein the integrating model is cloud based.

18. The integrating model of claim 13, wherein the data pre-processing is provided for communication between the individual models.

19. The integrating model of claim 13, wherein the machine-machine interface model is a REST API interface.

20. A method, comprising:
modelling a technical system composed of at least one of a machine, a component of a machine, and a technical process, with an integrating model comprising a plurality of individual models and a machine-machine interface;
assigning to each individual model a raw model and a data pre-processing; and
modeling a part of the technical system using different individual models.

21. The method of claim 20, wherein changing the data pre-processing when exchanging an individual model of the integrating model.

22. The method of claim 20, further comprising recording continuous measurement signals and transmitting the recorded continuous measurement signals in blocks for use in the integrating model.

23. The method of claim 22, further comprising changing a sampling rate or a block size depending on the individual model used.

24. The method of claim 20, further comprising activating or deactivating an individual model by operating a switch.
